(19) United States
(12) Patent Application Publication
(10) Pub. No.: US 2019/0267652 A1
(43) Pub. Date: Aug. 29, 2019

(54) Fuel Battery System and Fuel Battery System Operation Method

(71) Applicant: Sawafuji Electric Co., Ltd., Gunma (JP)

(72) Inventor: Tomonori Miura, Gunma (JP)

(21) Appl. No.: 16/333,976

(22) PCT Filed: Oct. 13, 2017
(86) PCT No.: PCT/JP2017/037161

§ 371 Date: Mar. 15, 2019

(30) Foreign Application Priority Data
Nov. 18, 2016 (JP) 2016-224911

(51) Int. Cl. H01M 8/04992; H01M 8/0444; H01M 8/0606; H01M 8/04858; H01M 8/04225; H01M 8/04082; H01M 8/04302

(52) U.S. Cl. CPC H01M 8/04992; H01M 8/0444; H01M 8/0606; H01M 8/04302; H01M 8/04225; H01M 8/04201; H01M 8/04932

(57) ABSTRACT

A fuel battery system is provided which can start up without receiving an energy supply from the outside. This fuel battery system 1 is provided with an input unit 11 which is connected to a hydrogen source 41, a reformer 12 which produces a hydrogen-containing gas, a hydrogen storage container 13, a fuel battery 15 which generates power using the hydrogen-containing gas, and a control unit 18. The control unit 18 stores a threshold value of the hydrogen-containing gas necessary for start-up of the fuel battery 15, and controls the amount stored in the hydrogen storage container 13 to be greater than or equal to the amount necessary for start-up of the fuel battery 15. Further, when starting up, the fuel battery 15 generates power by receiving a supply of the hydrogen-containing gas stored in the hydrogen storage container 13 and supplies power to the reformer 12 from a first power supply path 16. The reformer 12 starts up and the necessary hydrogen is produced.

### FIELD OF THE INVENTION

The present invention relates to fuel battery systems (fuel cell systems). In particular, the invention relates to a fuel battery system that includes a hydrogen-producing device and a fuel battery, which is capable of starting up and continuing operation without receiving an energy supply from the outside, such as during a power outage or natural disaster.

### DESCRIPTION OF THE RELATED ART

Fuel batteries (fuel cells) are known which use hydrogen and oxygen as fuel and generate energy through chemical reactions thereof. There are various kinds of fuel batteries, such as solid polymer fuel batteries that utilize an ion exchange membrane as the electrolyte, phosphoric acid fuel batteries that utilize phosphoric acid as the electrolyte, and molten carbonate fuel batteries that utilize lithium or potassium carbonate as the electrolyte. Out of these, solid polymer fuel batteries are starting to become widely adopted in households as they can operate at low temperatures of 100° C. or less, and can be miniaturized.

The hydrogen used as fuel in fuel batteries tends to be costlier to store and transport compared to other fuel gases. Because of this, many fuel battery systems include a hydrogen-producing device to produce hydrogen on-site. One known embodiment of a hydrogen-producing device is a reformer that produces hydrogen through a decomposing reaction using gaseous forms of ammonia, urea, or hydrocarbons as a hydrogen source.

The method for operating a fuel battery system having a reformer includes at least two steps: first starting up the reformer to produce hydrogen, and then supplying the produced hydrogen to start up the fuel battery and generate power. Starting up the reformer requires an energy supply from the outside, and in most cases electric power was received from an external electric power supply. In normal circumstances, the fuel battery system can be connected to an external electric power supply to easily receive energy. However, when the external energy supply was cut off due to a power outage, natural disaster or the like, starting up the stopped fuel battery system could be difficult.

In order to obviate the need for an external energy supply, techniques for storing energy needed to start up a fuel battery system in a storage battery are known. However, storage batteries having enough capacity to start up a reformer are expensive, and therefore a factor driving up the cost of the fuel battery system as a whole. Further, when using a storage battery as an emergency energy storage means, repeated charging and discharging gradually depletes the capacity of the storage battery, leading to the risk that the required electric power could not be supplied after a certain time of use.

Various techniques have been proposed for starting up a fuel battery system during power outages or natural disasters. Patent Document 1 discloses an emergency fuel battery system that can be started up by being connected to a power generating device of a vehicle or the like. Patent Documents 2 and 3 disclose fuel battery systems including start-up energy storage and supply means, such as storage batteries. In addition, Patent Document 4 discloses a technique for ensuring that the stopping period of a fuel battery system does not overlap with a power outage period based on power outage information obtained in advance.

Patent Document 5 discloses a fuel battery power generating system that includes a hydrogen storage device for storing part of the reformed gas for emergencies, which can maintain battery output of the fuel battery by discharging the stored hydrogen at a fuel switching time. The configuration of the hydrogen storage device of the fuel battery system disclosed in Patent Document 5 has the purpose of compensating for a temporary delay in response of the reformer at the fuel switching time, and does not address a complete stop and startup of the fuel battery system.

### PRIOR ART DOCUMENTS

### Patent Documents

Patent Document 1: Japanese Unexamined Patent Publication No. 2007-179886
Patent Document 2: Japanese Unexamined Patent Publication No. 2012-38559
Patent Document 3: Japanese Unexamined Patent Publication No. 2016-143619
Patent Document 4: Japanese Unexamined Patent Publication No. 2016-167382
Patent Document 5: Japanese Unexamined Patent Publication No. 1990-56866

### SUMMARY OF THE INVENTION

### Problem to be Solved by the Invention

Conventional fuel battery systems with reformers needed to be supplied with energy such as electric energy from the outside, or the reformer could not be started up, and as a result the fuel battery system could not be started up. This became a problem in that autonomous operation was not possible during power outages or natural disasters.

### Means for Solving the Problem

In order to overcome the aforementioned problem, the present invention provides a fuel battery system capable of starting up without receiving an energy supply from the outside. The fuel battery system according to the present invention includes an input unit which is connected to a hydrogen source and introduces a hydrogen-containing raw material, a reformer which decomposes the raw material introduced by the input unit to produce a hydrogen-containing gas, a hydrogen storage container which temporarily stores the hydrogen-containing gas produced by the reformer, a measurement unit which measures a storage amount of hydrogen-containing gas in the hydrogen storage container, a fuel battery that generates power using hydrogen-containing gas supplied from the hydrogen storage container, a first power supply path which supplies at least part of the power generated by the fuel battery to the reformer, a second power supply path which supplies part of the power generated by the fuel battery to the outside, and a control unit which receives measurement data from the measurement unit to control the amount of hydrogen-containing gas produced by the reformer, the amount of hydrogen-containing gas stored by the hydrogen storage container, and the amount of power generated by the fuel battery. The control unit according to the present invention stores a threshold value of the measurement data corresponding to the minimum amount of hydrogen-containing gas necessary for start-up of the fuel battery, and controls the storage amount of hydrogen-containing gas in the hydrogen storage container to be greater than or equal to the amount necessary for start-up of the fuel battery, based on the results of a comparison of the measurement data with the threshold value. Then, on start-up, the fuel battery generates power using the hydrogen-containing gas stored in the hydrogen storage container and supplies power to the reformer via the first power supply path.

During normal operation, the control unit of the fuel battery system according to the present invention performs control to ensure that an amount of hydrogen-containing gas necessary for start-up of the fuel battery is always stored in the hydrogen storage container. When starting up the fuel battery system, power generation is begun by supplying the hydrogen-containing gas stored in the hydrogen storage container to the fuel battery. Further, hydrogen production is begun by supplying power generated by the fuel battery to start up the reformer. The fuel battery can use the hydrogen produced by the reformer to continue generating power.

In the fuel battery system according to the present invention, the output power of the fuel battery is preferably greater than the power consumed by the reformer. In addition, the operating temperature of the fuel battery of the fuel battery system according to the present invention is preferably greater than or equal to the operating temperature of the reformer.

In the fuel battery system according to the present invention, the reformer which produces hydrogen-containing gas preferably includes a plasma reactor for decomposing raw material and turning it into plasma, the plasma reactor having a raw material supply port and a hydrogen discharge port, a power supply for plasma generation connected to the first power supply path, and a hydrogen separation unit that demarcates the hydrogen discharge port side of the plasma reactor. The hydrogen separation unit of the reformer is characterized in that it separates hydrogen from the raw material turned into plasma in the plasma reactor, and transmits the hydrogen to the hydrogen discharge port side.

Further, the hydrogen separation unit of the reformer according to the present invention is preferably a hydrogen separation membrane connected to the power supply for plasma generation. The hydrogen separation membrane is characterized in that it functions as a high-voltage electrode by being supplied with power, and discharges electricity between the hydrogen separation membrane and a grounding electrode to turn the raw material into plasma.

The fuel battery system according to the present invention further includes a control valve at a hydrogen supply side outlet of the hydrogen storage container, the degree of opening of which is preferably controlled by the control unit. The control unit is characterized in that it controls the amount of hydrogen-containing gas stored in the hydrogen storage container by controlling the degree of opening.

The hydrogen-containing raw material is preferably ammonia or urea. By using ammonia or urea as the raw material, adhesion of carbon to the hydrogen separation membrane of the reformer can be prevented compared to when a hydrocarbon gas is used as the hydrogen source, which makes it possible to prevent deterioration of the hydrogen separation membrane.

The present invention also provides an operating method of a fuel battery system. The operating method of the fuel battery system according to the present invention is applied to a fuel battery system including an input unit which is connected to a hydrogen source and introduces a hydrogen-containing raw material from the hydrogen source, a reformer which decomposes the raw material introduced by the input unit to produce a hydrogen-containing gas, a hydrogen storage container which temporarily stores the hydrogen-containing gas produced by the reformer, a measurement unit which measures a storage amount of hydrogen-containing gas in the hydrogen storage container, a fuel battery that generates power using hydrogen-containing gas supplied from the hydrogen storage container, a first power supply path which supplies at least part of the power generated by the fuel battery to the reformer, a second power supply path which supplies part of the power generated by the fuel battery to the outside, and a control unit. The control unit of the fuel battery system receives measurement data from the measurement unit to control the amount of hydrogen-containing gas produced by the reformer, the storage amount of hydrogen-containing gas in the hydrogen storage container, and the amount of power generated by the fuel battery. The control unit stores a threshold value of the measurement data corresponding to the minimum amount of hydrogen-containing gas necessary for start-up of the fuel battery. By comparing and judging the measurement data input from the measurement unit and the stored threshold value, the control unit performs feedback control of the storage amount of hydrogen-containing gas in the hydrogen storage container to be greater than or equal to the amount necessary for start-up of the fuel battery. The operating method of the fuel battery system according to the present invention is characterized in that it includes a step wherein the control unit, having received a start-up order, supplies hydrogen-containing gas from the hydrogen storage container to the fuel battery, a step wherein the fuel battery starts generating power using the supplied hydrogen-containing gas, a step wherein power generated by the fuel battery is supplied to the reformer, a step wherein the reformer produces hydrogen by decomposing the raw material and turning it into plasma, and a step wherein the produced hydrogen-containing gas is supplied to the fuel battery to continue generating power.

### Effects of the Invention

The fuel battery system according to the present invention is capable of starting up autonomously and starting power generation without receiving an energy supply such as electric energy from the outside. Moreover, the fuel battery system according to the present invention is capable of starting up autonomously and starting power generation without the need for a storage battery or the like for start-up.

Since the output power of the fuel battery of the fuel battery system according to the present invention is greater than the power consumed by the reformer, a sufficient amount of hydrogen-containing gas for power generation can be produced using only the power supplied by the fuel battery. As a result, a sufficient amount of hydrogen can be supplied to the fuel battery, which allows for stable operation of the fuel battery and continued power generation. In other words, the fuel battery system according to the present invention is capable of autonomous operation in addition to autonomous start-up.

Since the operating temperature of the fuel battery of the fuel battery system according to the present invention is greater than or equal to the operating temperature of the reformer, a cooling means for the hydrogen-containing gas supplied from the reformer is not necessary. This allows for a simpler construction of the fuel battery system as a whole, and allows for reduced power consumption. It also allows the system to be installed in a wider range of locations.

By composing the reformer of the fuel battery system according to the present invention of a plasma reactor, a power supply for plasma generation, and a hydrogen separation unit, it is possible to cause an electric discharge between the hydrogen separation membrane and a grounding electrode under room temperature and atmospheric pressure conditions to turn the hydrogen-containing raw material into plasma and thereby produce hydrogen-containing gas. Since the reformer according to the present invention is a plasma reformer that operates at room temperature and atmospheric pressure, there is no need for a heating means as in other kinds of reformers, which allows for a simpler construction of the system as a whole, and allows for operation using less energy.

Since the fuel battery system according to the present invention applies a solid polymer fuel battery with an operating temperature of 100° C. or less, power can be generated using room-temperature hydrogen supplied from the reformer, thus simplifying the thermal design of the fuel battery system as a whole. Without the need for a heating means for the reformer or a cooling means for the hydrogen storage container, the fuel battery system as a whole can have a simpler construction, and power consumption can be reduced. As a result, the fuel battery system can be made cheaper and smaller.

### BRIEF DESCRIPTION OF THE DRAWINGS

FIG. 1 is a block diagram showing the configuration of the fuel battery system according to an embodiment of the present invention.

FIG. 2 is a flowchart showing the start-up sequence of the fuel battery system according to an embodiment of the present invention.

FIG. 3 is a flowchart showing the stop sequence of the fuel battery system according to an embodiment of the present invention.

FIG. 4 is a schematic view of the vertical cross-section of the reformer according to an embodiment of the present invention.

FIG. 5 is a graph showing the relationship between the power consumption and hydrogen production amount of the reformer according to the Examples.

FIG. 6 is a graph showing the relationship between the hydrogen supply rate and power generation rate of the fuel battery according to the Examples.

### DESCRIPTION OF THE EMBODIMENTS

Below is an itemized description of a preferred embodiment of the present invention.
(1) “Autonomous start-up” of the fuel battery system according to the present invention means that the reformer and fuel battery can be started up without receiving electric energy or an equivalent energy supply from the outside, whereupon power generation can be started and energy supplied to an external load.
(2) The “hydrogen source” refers to a means for storing a hydrogen-containing raw material and supplying this substance as raw material to the fuel battery system according to the present invention. More specifically, it refers to a storage container for a hydrogen-containing raw material, or a supply pipe in communication with this storage container. The substance stored or supplied by the hydrogen source is ammonia, urea, or a hydrocarbon gas such as methane or the like.
(3) The “reformer” refers to a device for producing hydrogen using a hydrogen-containing substance as raw material. The reformer according to the most preferred embodiment is a plasma reformer which includes a plasma reactor, a power supply for plasma generation, a hydrogen separation unit functioning as a high-voltage electrode, and a grounding electrode, the reformer turning the hydrogen-containing substance into plasma by causing an electric discharge between the electrodes, and allowing only hydrogen to pass through the hydrogen separation unit.
(4) As a reformer equivalent to a plasma reformer, a reformer which decomposes the hydrogen-containing substance using a catalyst to extract hydrogen, and a reformer combining a plasma reaction with a catalyst reaction, may be applied.
(5) Due to the hydrogen separation membrane, the hydrogen-containing gas produced by the plasma reformer has a hydrogen concentration of 99.9% or higher.
(6) During normal operation, the control unit performs the following control:
Controls the amount of hydrogen-containing raw material that is introduced into the input unit from the hydrogen source.
Stores the threshold value of the storage amount of the hydrogen storage container corresponding to a minimum amount of hydrogen-containing gas necessary for start-up of the fuel battery. Monitors and controls measurement data output by the measurement unit, compares the storage amount of the hydrogen storage container based on the measurement data with the stored threshold value, and uses the results of the comparison to perform feedback control of the amount of hydrogen-containing gas produced by the reformer. By controlling the amount of hydrogen-containing gas produced by the reformer, the control unit regulates the amount of hydrogen-containing gas stored in the hydrogen storage container.
Controls an oxygen supply means to control an amount of oxygen supplied to the fuel battery.
Controls the degree of opening of the control valve connected to the hydrogen storage container to thereby control the amount of power generated by the fuel battery.
Monitors the amount of power generated by the fuel battery to control the amount of power supplied to the reformer.
(7) When the control unit detects an anomaly such as a power outage or natural disaster, and has received a stop order from the outside, the control unit checks the storage amount of the hydrogen storage container and stops power generation.
(8) When the control unit has received a start-up order from the outside and a pre-planned time is reached, it executes the start-up sequence of the fuel battery system.
(9) A pressure gauge that measures the pressure of the hydrogen storage container can be applied as the measurement unit. Alternatively, a weight sensor that measures the weight of the gas stored in the hydrogen storage container may be used.
(10) The fuel battery most preferably used in the fuel battery system according to the present invention is a solid polymer fuel battery. Other types of fuel batteries can also be used.

A preferred embodiment of the fuel battery system according to the present invention is described below with reference to the drawings.

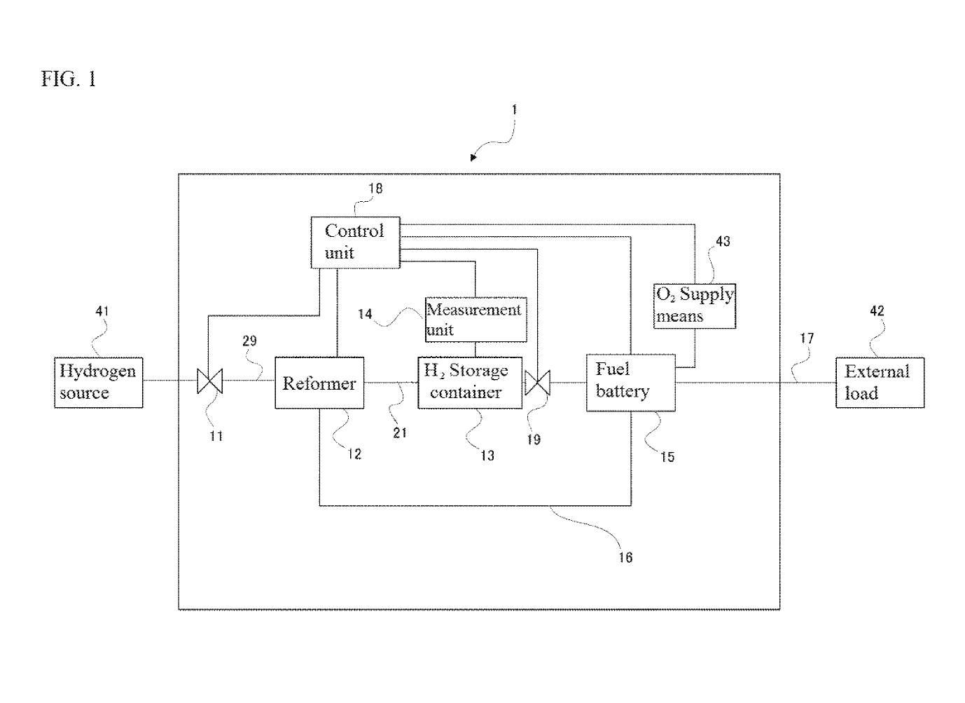

The fuel battery system according to the present invention and the operating method of the system will now be described with reference to FIGS. 1 to 4. The fuel battery system 1 (fuel cell system 1) shown in FIG. 1 includes an input unit 11, a reformer 12, a hydrogen storage container 13, a measurement unit 14, a fuel battery 15 (fuel cell 15), and a control unit 18. The outlet side of the hydrogen storage container 13 is provided with a control valve 19. The control unit 18 is connected in communication respectively with the input unit 11, the reformer 12, the measurement unit 14, the fuel battery 15, an oxygen supply means 43, and the control valve 19. The fuel battery 15 is connected to a first power supply path 16 that supplies at least part of the generated power to the reformer, and to a second power supply path 17 that supplies power to an external load 42.

The input unit 11 is connected to a hydrogen source 41 that stores and supplies a hydrogen-containing raw material, and introduces raw material received from the hydrogen source 41 to the reformer 12 via a raw material inlet path 29. The input unit 11 is preferably composed of a solenoid valve. The control unit 18 controls the degree of opening of the input unit 11 to control the amount of raw material introduced, and thereby controls the amount of hydrogen-containing gas produced by the reformer 12.

The reformer 12 decomposes a predetermined amount of raw material introduced via the raw material inlet path 29 to produce hydrogen-containing gas. The produced hydrogen-containing gas is temporarily stored in the hydrogen storage container 13 via a hydrogen supply path 21. The measurement unit 14 is connected to the hydrogen storage container 13, and measures the amount of hydrogen-containing gas stored in the hydrogen storage container 13. The measurement unit 14 is preferably a pressure gauge that measures the pressure inside the hydrogen storage container 13. The measured value of the measured pressure is input into the control unit 18. The control unit 18 stores a threshold value of the storage amount of the hydrogen storage container 13 corresponding to the minimum amount of hydrogen-containing gas necessary for start-up of the fuel battery 15 (hereinafter referred to as “start-up hydrogen amount”), and monitors and controls the storage amount. In a case where the measurement unit 14 is a pressure gauge, and the output measurement data is a pressure value, the threshold value stored by the control unit 18 is also a pressure value.

The control valve 19 is arranged on the outlet side of the hydrogen storage container 13. The control valve 19 is preferably composed of a solenoid valve. The control unit 18 controls the degree of opening of the control valve 19 to control the storage amount of the hydrogen storage container 13 and the amount of hydrogen-containing gas supplied to the fuel battery 15.

The fuel battery 15 uses hydrogen-containing gas supplied from the hydrogen storage container 13 and oxygen in air supplied from the oxygen supply 43 means to generate power. The fuel battery 15 is preferably a solid polymer fuel battery with an operating temperature of 100° C. or less. The power output by the fuel battery is distributed and supplied to the first power supply path 16 and the second power supply path 17. The control unit 18 monitors the amount of power generated by the fuel battery 15 and secures a necessary amount of generated power. In order to do this, the control unit 18 controls the degree of opening of the control valve 19 and the amount of oxygen supplied from the oxygen supply means 43. The oxygen supply means 43 is preferably an ordinary fan.

During normal operation, the control unit 18, in addition to performing control for achieving a required amount of generated power, constantly performs control to store a minimum amount of hydrogen-containing gas necessary for start-up of the fuel battery 15 in the hydrogen storage container 13. Upon receiving measurement data from the measurement unit 14, the control unit 18 compares the measurement data to the stored threshold value. If it is determined based on the results of the comparison that the stored hydrogen-containing gas is below the start-up hydrogen amount, the control unit 18 performs feedback control to increase the storage amount of hydrogen-containing gas. Specifically, the control unit 18 controls the input unit 11 to increase the amount of raw material supplied to the reformer 12, and performs control to increase the power supplied from the fuel battery 15 to the reformer 12 to swiftly increase the amount of hydrogen-containing gas produced by the reformer 12, so that the storage amount of the hydrogen storage container 13 becomes greater than or equal to the start-up hydrogen amount.

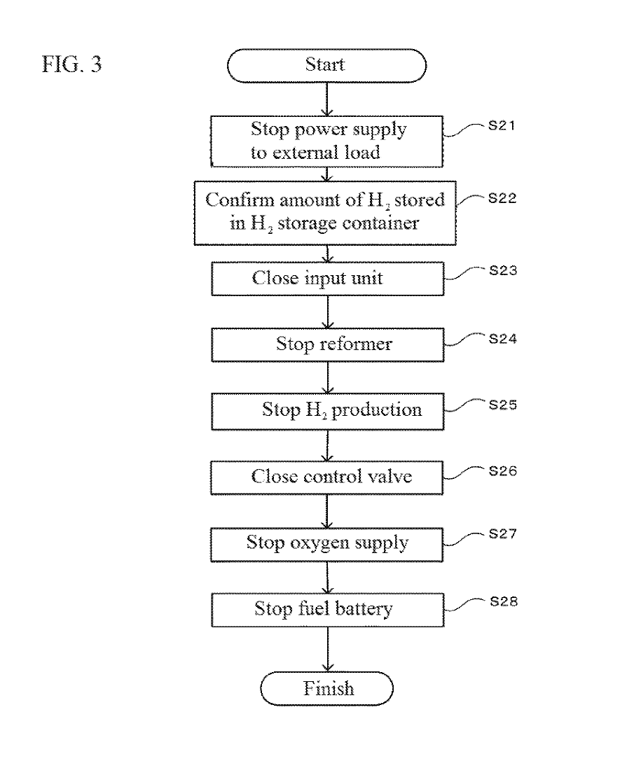

The stopping method of the fuel battery system 1 will now be described with reference to FIG. 3. The series of steps for stopping the fuel battery system 1 is entirely performed by the control of the control unit 18. When the fuel battery system 1 stops supplying power to the external load 42 via the second power supply path 17 (Step S21), the control unit 18 checks the measurement data of the measurement unit 14, and confirms that the start-up hydrogen amount is stored in the hydrogen storage container 13 (Step S22). Following confirmation, the control unit 18 closes the input unit 11 (Step S23) and stops the reformer 12 (Step S24). When the control unit 18 has confirmed that hydrogen production has stopped completely (Step S25), it closes the control valve 19 and closes the hydrogen storage container 13 (Step S26). This stops supply of hydrogen to the fuel battery 15. Next, the control unit 18 stops the oxygen supply means 43 to stop oxygen supply to the fuel battery 15 (Step S27). Finally, the control unit 18 stops operation of the fuel battery 15 (Step S28). By these steps, the fuel battery system 1 is completely stopped with the start-up hydrogen amount stored in the hydrogen storage container 13.

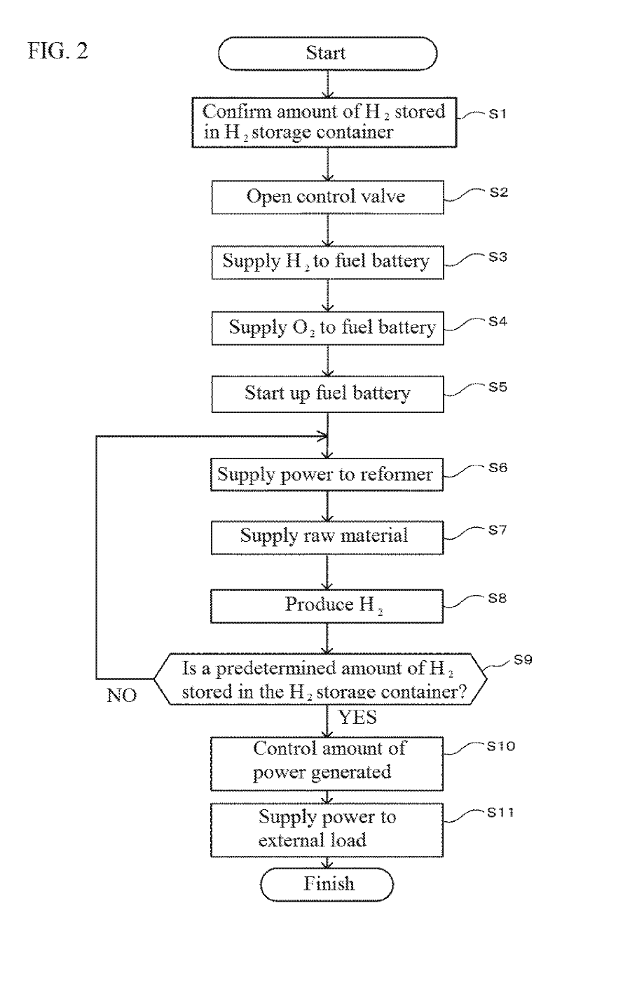

The start-up method of the fuel battery system 1 with the start-up hydrogen amount stored in the hydrogen storage container 13 will now be described with reference to FIG. 2. Start-up is performed by the control of the control unit 18. The control unit 18 checks the amount of hydrogen stored in the hydrogen storage container 13 (Step 51), opens the control valve 19 (Step S2), and supplies hydrogen from the hydrogen storage container 13 to the fuel battery 15 (Step S3). The control unit 18 supplies oxygen from the oxygen supply means 43 to the fuel battery 15 (Step S4), and starts the fuel battery 15 (Step S5). This initiates power generation. At the start of the power generation, the control unit 18 supplies all of the generated power to the reformer 12 via the first power supply path 16 (Step S6). The control unit 18 then opens the input unit 11 and introduces raw material into the reformer 12 (Step S7). The reformer 12 starts up, initiating hydrogen production (Step S8). The control unit 18 checks the measurement data of the measurement unit 14 again, and checks whether an amount of hydrogen-containing gas greater than or equal to the start-up hydrogen amount is stored in the hydrogen storage container 13 (Step S9). When the storage amount is ensured, the result of Step S9 will be YES, and the control unit 18 initiates normal operation and controls the amount of power generated (Step S10). The control unit 18 then initiates supply of power to the external load 42 via the second power supply path (Step S11).

When the normal stopping method illustrated in FIG. 3 is performed, an amount of hydrogen greater than or equal to the start-up hydrogen amount is always stored in the hydrogen storage container 13 of the fuel battery system 1. Only when starting up a completely newly installed fuel battery system 1 can the fuel battery 15 be started up by introducing an amount of hydrogen-containing gas necessary for start-up of the fuel battery 15 into the hydrogen storage container 13.

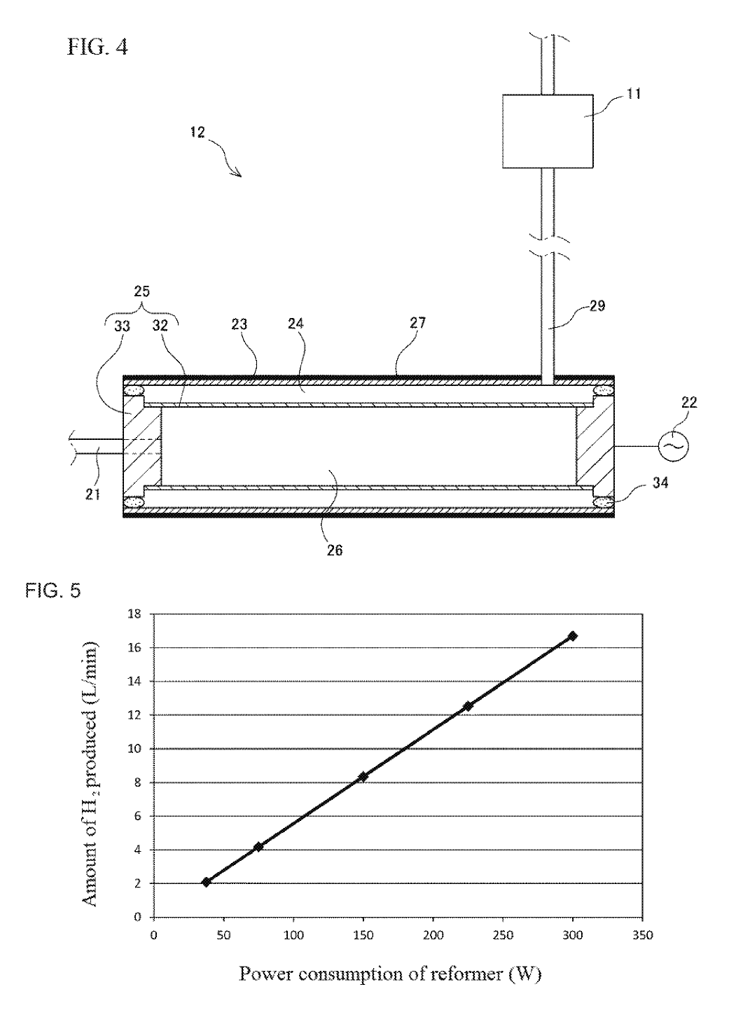

The reformer 12 preferably used in the present embodiment will now be described with reference to FIG. 4. The reformer 12 is a plasma reformer which includes a plasma reactor 23, a high-voltage electrode 25 housed within the plasma reactor 23, and a grounding electrode 27 arranged in contact with the outside of the plasma reactor 23. The plasma reactor 23 is made of quartz, and is formed in a cylindrical shape. The high-voltage electrode 25 includes a cylindrical hydrogen separation membrane 32, and disc-shaped supports 33 that support both ends of the hydrogen separation membrane 32. The hydrogen separation membrane 32 is preferably a thin film of a palladium alloy.

The high-voltage electrode 25 is connected to a high-voltage pulsed power supply 22 which is connected to the fuel battery 15 via the first power supply path 16, and is provided with a high voltage. O-rings 34 are fitted between the plasma reactor 23 and the supports 33 such that the hydrogen separation membrane 32 is arranged concentrically with the inner wall of the plasma reactor 23. As a result, a discharge space 24 in which a constant distance is maintained is formed between the inner wall of the plasma reactor 23 and the hydrogen separation membrane 32. In addition, on the inside of the hydrogen separation membrane 32, there is formed a sealed internal chamber 26 enclosed by the hydrogen separation membrane 32 and the supports 33. The grounding electrode 27 is arranged concentrically with the plasma reactor 23 and the hydrogen separation membrane 32. In the present embodiment, the most suitable raw material supplied from the hydrogen source 41 via the input unit 11 and the raw material inlet path 29 is ammonia gas. This ammonia gas is supplied to the discharge space 24 of the reformer 12.

The hydrogen separation membrane 32 and the grounding electrode 27 face each other, and the plasma reactor 23 made of quartz is arranged between them, so that the plasma reactor 23 acts as a dielectric, which allows for a dielectric barrier discharge to be generated by applying a high voltage to the high-voltage electrode 25 in the form of the hydrogen separation membrane 32. The high-voltage pulsed power supply 22 that applies the high voltage to the high-voltage electrode 25 applies a voltage with an extremely short retention time of 10 μs.

Production of hydrogen using the reformer 12 is carried out by supplying ammonia gas to the discharge space at a predetermined flow rate, generating a dielectric barrier discharge between the hydrogen separation membrane 32 acting as the high-voltage electrode 25 and the grounding electrode 27, and generating atmospheric pressure non-equilibrium plasma of ammonia in the discharge space 24. The hydrogen generated from the atmospheric pressure non-equilibrium plasma of ammonia is adsorbed by the hydrogen separation membrane 32 in the form of hydrogen atoms, which scatter as they pass through the hydrogen separation membrane 32, after which they recombine into hydrogen molecules and move into the internal chamber 26. In this way only the hydrogen is separated.

The reformer 12 described herein operates at room temperature. When ammonia is used, approximately 100% of the hydrogen contained in the ammonia can be separated and introduced into the internal chamber 26. As a result, the obtained hydrogen-containing gas is a hydrogen gas with a purity of 99.9% or more.

### EXAMPLES

Below is shown an Example of autonomous start-up of the fuel battery system 1 applying a plasma reformer as the reformer 12 and a solid polymer fuel battery as the fuel battery 15. The present Example employs a solid polymer fuel battery having a start-up hydrogen amount of 50 liters (0.05 m³) at 0.1 MPa (1 standard atmosphere).

In the present Example, a pressure gauge is employed as the measurement unit 14 for measuring the storage amount of the hydrogen-containing gas in the hydrogen storage container 13. The control unit 18 stores a threshold value of pressure corresponding to the amount of hydrogen-containing gas necessary for start-up of the fuel battery 15. During power generation, the control unit 18 monitors the measured results of the measurement unit, performs feedback control of the amount of hydrogen-containing gas produced by the reformer 12 and the storage amount of the hydrogen storage container 13 using the results of a comparison of the stored threshold value with the measured results, and constantly stores hydrogen-containing gas corresponding to the hydrogen amount of 50 liters necessary for start-up.

The reformer 12 of the present Example is a plasma reformer which includes a plasma reactor 23, a high-voltage electrode 25 housed within the plasma reactor 23, and a grounding electrode 27 arranged in contact with the outside of the plasma reactor 23. An example of the relationship between the power consumed by the plasma reformer and the amount of hydrogen produced is shown in Table 1 and FIG. 5. The volumes shown below are calculated based on standard conditions (1 standard atmosphere, 0° C.).

TABLE 1

| Power consumed by the plasma | Amount of hydrogen produced |
|---|---|
| reformer (Wh) | (L/min) |
| 37.5 | 2.09 |
| 75 | 4.18 |
| 150 | 8.35 |
| 225 | 12.53 |
| 300 | 16.70 |

As shown in Table 1 and FIG. 5, the plasma reformer constituting the reformer 12 in the present Example can produce hydrogen in proportion to the supplied power. Specifically, when the raw material ammonia is supplied at 1.39 liters per minute (calculated based on standard conditions), 2.09 liters of hydrogen is produced per minute with a power consumption of 37.5 W. As such, 5.57 liters of hydrogen is produced per minute with a power consumption of 100 W.

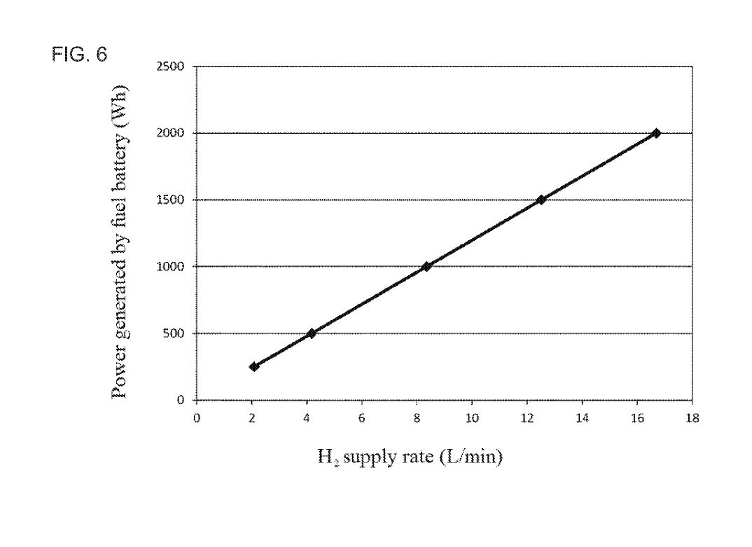

An example of the relationship between the amount of hydrogen supplied and the amount of power generated by the solid polymer fuel battery applied in the present Example is shown in Table 2 and FIG. 6. The fuel battery 15 according to the present Example can generate power in proportion to the amount of hydrogen supplied.

| Power generated by the fuel | Amount of hydrogen supplied |
|---|---|
| battery (Wh) | (L/min) |
| 250 | 2.09 |
| 500 | 4.18 |
| 1000 | 8.35 |
| 1500 | 12.53 |
| 2000 | 16.70 |

The control unit 18 supplies part of the power generated by the fuel battery 15 to the reformer 12. This power starts up the reformer 12 and generates a dielectric barrier discharge between the high-voltage electrode 25 in the form of the hydrogen separation membrane 32 and the grounding electrode 27, initiating hydrogen production. By supplying 150 W of the 1000 W of power generated by the fuel battery 15 to the reformer 12, hydrogen necessary for power generation by the fuel battery 15 can be produced. In this way, the fuel battery 15 and the reformer 12 can start up, and power generation can be continued.

The configuration and operation method of the fuel battery system 1 described in the present embodiment may be altered as necessary. For example, in a variant of the reformer 12, the cylindrical hydrogen separation membrane 32 housed in the plasma reactor 23 may be grounded, and an electrode arranged in contact with the outside of the plasma reactor 23 may be connected to the high-voltage pulsed power supply 22. At this time, the hydrogen separation membrane 32 acts as the grounding electrode, and a dielectric barrier discharge can be generated like in the Example. Even in this case, the hydrogen separation membrane 32 is exposed to the plasma, allowing for separation of hydrogen.

In the present embodiment, an example was described in which the hydrogen storage container 13 and the control valve 19 were arranged in separate locations, but the control valve 19 can also be arranged at the outlet of the hydrogen storage container 13. In addition, the measurement unit 14 that measures the storage amount of the hydrogen storage container 13 may be another measurement device apart from a pressure gauge. Any means for controlling the flow rate can be arranged in the hydrogen supply path 21 from the reformer 12 to the fuel battery 15 via the hydrogen storage container 13. The wiring and current voltage control means of the power supply paths 16 and 17 for supplying power from the fuel battery 15 to the reformer 12 and the external load 42 can also be altered depending on the overall arrangement and function of the device as a whole.

### Description of the Reference Numerals

1 fuel battery system
11 input unit
12 reformer
13 hydrogen storage container
14 measurement unit
15 fuel battery
16 first power supply path
17 second power supply path
18 control unit
19 control valve
21 hydrogen supply path
22 high-voltage pulsed power supply
23 plasma reactor
24 discharge space
25 high-voltage electrode
27 grounding electrode
29 raw material inlet path
32 hydrogen separation membrane
33 support
41 hydrogen source
42 external load
43 oxygen supply means

1. A fuel battery system comprising:
an input unit connected to a hydrogen source and configured to introduce hydrogen-containing raw material from the hydrogen source;
a reformer configured to decompose the raw material introduced by the input unit to produce a hydrogen-containing gas;
a hydrogen storage container configured to temporarily store the hydrogen-containing gas produced by the reformer;
a measurement unit configured to measure a storage amount of hydrogen-containing gas in the hydrogen storage container;
a fuel battery configured to generate power using hydrogen-containing gas supplied from the hydrogen storage container;
a first power supply path configured to supply at least part of the power generated by the fuel battery to the reformer;
a second power supply path configured to supply part of the power generated by the fuel battery to the outside; and
a control unit configured to receive measurement data from the measurement unit and control the amount of hydrogen-containing gas produced by the reformer, the storage amount of hydrogen-containing gas of the hydrogen storage container, and the amount of power generated by the fuel battery,
characterized in that the control unit stores a threshold value of the measurement data corresponding to a minimum amount of hydrogen-containing gas necessary for start-up of the fuel battery, and controls the storage amount of hydrogen-containing gas of the hydrogen storage container to be greater than or equal to the amount necessary for start-up of the fuel battery based on results of a comparison of the measurement data with the threshold value, and
the fuel battery on start-up uses hydrogen-containing gas stored in the hydrogen storage container to generate power, and supplies power to the reformer via the first power supply path.

2. The fuel battery system according to claim 1, characterized in that the output power of the fuel battery is greater than the power consumed by the reformer.

3. The fuel battery system according to claim 1, characterized in that an operating temperature of the fuel battery is greater than or equal to an operating temperature of the reformer.

4. The fuel battery system according to claim 1, characterized in that the reformer comprises:
a plasma reactor for decomposing the raw material and turn it into plasma, the plasma reactor having a raw material supply port and a hydrogen discharge port;
a power supply for plasma generation connected to the first power supply path; and
a hydrogen separation unit that demarcates the hydrogen discharge port side of the plasma reactor,
wherein the hydrogen separation unit separates hydrogen from the raw material turned into plasma inside the plasma reactor and transmits the hydrogen to the hydrogen discharge port side.

5. The fuel battery system according to claim 4, characterized in that the hydrogen separation unit is a hydrogen separation membrane connected to the power supply for plasma generation, wherein the hydrogen separation membrane acts as a high-voltage electrode by being supplied with power, and causes an electric discharge between the hydrogen separation membrane and a grounding electrode to turn the raw material into plasma.

6. The fuel battery system according to claim 1, characterized in that the hydrogen storage container further comprises a control valve on a hydrogen supply side outlet, wherein the control unit controls a degree of opening of the control valve to control the storage amount of hydrogen-containing gas of the hydrogen storage container.

7. The fuel battery system according to claim 1, characterized in that the hydrogen-containing raw material is ammonia or urea.

8. An operating method of a fuel battery system, the system comprising:
an input unit connected to a hydrogen source and configured to introduce hydrogen-containing raw material from the hydrogen source;
a reformer configured to decompose the raw material introduced by the input unit to produce a hydrogen-containing gas;
a hydrogen storage container configured to temporarily store the hydrogen-containing gas produced by the reformer;
a measurement unit configured to measure a storage amount of hydrogen-containing gas in the hydrogen storage container;
a fuel battery configured to generate power using hydrogen-containing gas supplied from the hydrogen storage container;
a first power supply path configured to supply at least part of the power generated by the fuel battery to the reformer;
a second power supply path configured to supply part of the power generated by the fuel battery to the outside; and
a control unit configured to receive measurement data from the measurement unit and control the amount of hydrogen-containing gas produced by the reformer, the storage amount of hydrogen-containing gas of the hydrogen storage container, and the amount of power generated by the fuel battery, the control unit comparing a threshold value corresponding to a minimum amount of hydrogen-containing gas necessary for start-up of the fuel battery with the measurement data of the measurement unit to perform feedback control of the amount of hydrogen-containing gas produced in order to control the storage amount of the hydrogen storage container to be greater than or equal to the amount necessary for start-up of the fuel battery,
the method comprising the following steps:
the control unit, having received a start-up order, supplies hydrogen-containing gas from the hydrogen storage container to the fuel battery;
the fuel battery initiates power generation by means of the supplied hydrogen-containing gas;
the fuel battery supplies generated power to the reformer;
the reformer produces hydrogen by decomposing the raw material and turning it into plasma; and
produced hydrogen-containing gas is supplied to the fuel battery to continue power generation.
